(19) United States
(12) Patent Application Publication
(10) Pub. No.: US 2005/0289164 A1
(43) Pub. Date: Dec. 29, 2005

(54) Method and apparatus for sorting and displaying files and folders based on frequency of use

(75) Inventor: Sung-min Yoon, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/165,245

(22) Filed: Jun. 24, 2005

(30) Foreign Application Priority Data
Jun. 26, 2004 (KR) 2004-48640

(51) Int. Cl. G06F 7/00

(52) U.S. Cl. 707/100

(57) ABSTRACT

A method of, and an apparatus to perform, sorting files and/or folders based on frequencies of use, the sorting including inputting a frequency sorting selection so that the files and/or lower folders in a specific folder are sorted based on the frequencies of use; accessing a frequency database including information regarding the frequencies of the files and/or lower folders in the folder in which the frequency sorting is performed in response to the frequency sorting selection, sorting the files and/or lower folders in the folder based on the frequencies in the frequency database, and displaying the result of the sorting.

### CROSS-REFERENCE TO RELATED APPLICATION

This application claims the benefit of Korean Patent Application No. 10-2004-48640, filed on Jun. 26, 2004 in the Korean Intellectual Property Office, the disclosure of which is incorporated herein by reference.

### BACKGROUND OF THE INVENTION

1. Field of the Invention

The present invention relates to a method of, and an apparatus to perform, sorting and displaying a file or a folder (hereinafter referred to as “a file”) based on frequency of use by a user, and, more particularly, to a method of, and an apparatus to perform, sorting files based on the frequency of use in which information regarding frequencies of use of a file is managed as a database (DB). When a user uses a file, the information regarding the frequencies in the DB is corrected such that a file can be sorted based on the frequency of use, and a necessary file can be quickly sought.

2. Description of the Related Art

Recently, due to increases in the size of hard discs, devices such as personal computers (PCs), MP3 players, etc., having a capacity of several hundreds of gigabytes (GB) have been manufactured. As the capacity of hard discs increases, more data can be stored, but the data seek time increases. In order to reduce seek time, file seekers are provided with various sorting methods.

FIG. 1 illustrates a sorting method provided by a conventional WINDOWS® seeker. Referring to FIG. 1, the conventional WINDOWS® seeker can show a user the name, size, type, modification date, writing date, characteristics, owner, and author, etc., (110) of a file as information regarding the file. The information can be used as criteria for sorting a file. Thus, when the user selects a criterion for sorting a file, all files and folders inside a corresponding folder are sorted and displayed according to the criterion. For example, when the user clicks a tab 120 called “name” using a mouse, WINDOWS® sorts all folders and files displayed on a current window in ascending or descending order based on the name of a file. FIG. 1 illustrates a case in which all files in the testcase folder are sorted based on names, in ascending order, in response to the user clicking the “name” tab 120.

When the user clicks the “name” tab 120 and then a “type” tab 130, all files and folders in the current folder are sorted based on the types of files, and then according to the names of the files in a subgroup of the type of each file by reflecting the previous result of sorting.

Thus, when the user wants to seek a specific file or folder, a file is sorted according to the above-described sorting criteria provided by the WINDOWS® seeker, and folders of a path to a file to be sought are clicked on. As the number of folders and files in a hard disc having a large capacity increases, it takes more time to seek a specific file or folder using only the sorting method provided by the conventional WINDOWS® seeker. Thus, a sorting method by which a file can be quickly sought is needed.

### SUMMARY OF THE INVENTION

The present invention provides a sorting method and apparatus in which the number of times a file is used is stored in a database (DB) in a corresponding folder, and a user selects the number of times of use as a sorting criterion such that files and folders are sorted according to the number of times they are used using information in the DB. By using the sorting method and apparatus in a manner in which a file frequently used by the user is placed in an upper position of a display apparatus based on the user's behavior pattern, such as the number of times of use, the time required to seek a necessary file can be reduced.

The present invention also provides a sorting method and apparatus in which the number of times a file is used is managed as an independent hierarchical DB such that even though the capacity of a hard disc increases, a file can be quickly sorted without incurring a performance reduction due to the DB.

Additional aspects and/or advantages of the invention will be set forth in part in the description which follows and, in part, will be apparent from the description, or may be learned by practice of the invention.

According to an aspect of the present invention, there is provided an apparatus to sort files and/or folders based on frequencies of use, the apparatus including: an input module to receive a frequency sorting selection regarding a specific folder; a frequency database including information regarding frequencies of the files and/or lower folders in the folder in which frequency sorting is performed in response to the frequency sorting selection; a database management module to create and manage the frequency database; a control module to sort the files and/or lower folders according to the frequencies provided by the database management module; and an output module to display the result of sorting performed by the control module.

According to another aspect of the present invention, there is provided a method of sorting files and/or folders based on frequencies of use, the method including: inputting a frequency sorting selection so that the files and/or lower folders in a specific folder are sorted based on frequencies of use; accessing a frequency database including information regarding the frequencies of the files and/or lower folders in the folder in which frequency sorting is performed in response to the frequency sorting selection; sorting the files and/or lower folders in the folder by the frequencies in the frequency database; and displaying the result of sorting.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a sorting method provided by a conventional WINDOWS® seeker;

FIG. 2 illustrates a structure of an apparatus to sort files and folders based on frequency of use according to an embodiment of the present invention;

FIG. 3 illustrates a hierarchy structure of example files and folders;

FIG. 4 illustrates a frequency database corresponding to the files and folders having the hierarchy structure shown in FIG. 3 according to an embodiment of the present invention;

FIG. 5 is a flowchart illustrating a method of sorting files and folders based on frequency of use according to an embodiment of the present invention;

FIG. 6 is a flowchart of a processing operation, resulting from a folder being opened, of the method of sorting files and folders based on the frequency of use according to an embodiment of the present invention;

FIG. 7 is a flowchart of a processing operation, resulting from a file being opened, of the method of sorting files and folders based on the frequency of use according to an embodiment of the present invention;

FIG. 8 is a flowchart of a processing operation resulting from a file being created, according to an embodiment of the present invention;

FIG. 9 is a flowchart of a processing operation resulting from a file being deleted, according to an embodiment of the present invention;

FIG. 10 is a flowchart of a processing operation resulting form a file being moved or copied, according to an embodiment of the present invention;

FIG. 11 illustrates frequency sorting according to an embodiment of the present invention;

FIG. 12 illustrates a sorting method resulting from a plurality of files, etc., having the same frequencies existing, according to an embodiment of the present invention; and

FIG. 13 illustrates a user interface used to select frequency sorting according to an embodiment of the present invention.

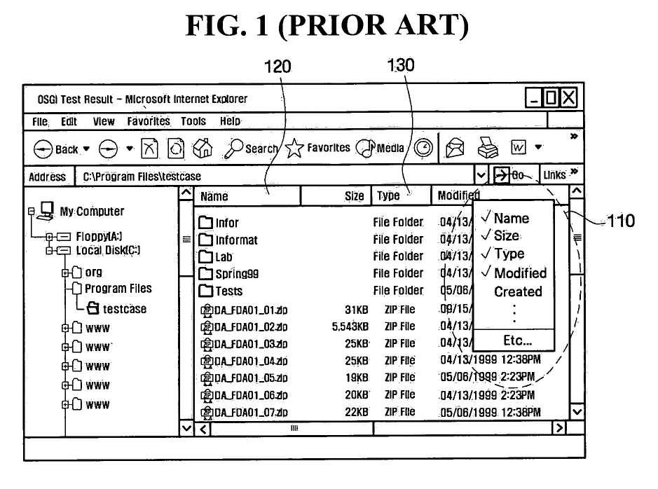

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The present invention may, however, be embodied in many different forms, and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Before describing these embodiments of the present invention, terms used in the specification will now be described briefly. However, it is noted that the use of any and all examples, or terms provided herein, is intended merely to better illuminate the invention, and is not a limitation on the scope of the invention unless otherwise claimed. Further, although WINDOWS® is used as a software application in many of the following embodiments, it is understood that the use thereof is merely for illustrative purposes, and the present invention may be incorporated in any of a number of systems.

In the present specification, frequencies are numbers of times of use of a file and/or folder. The number of times of use includes, for example, modifying a file and reading a file.

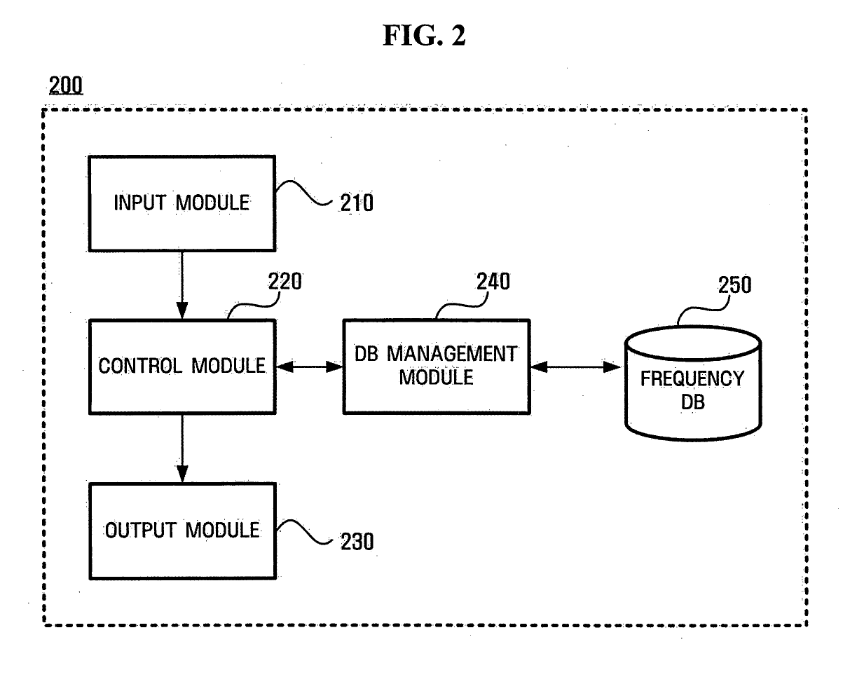

FIG. 2 illustrates a structure of an apparatus to sort files and folders based on frequency of use according to an embodiment of the present invention.

Referring to FIG. 2, the apparatus to sort files and folders based on the frequency of use includes an input module 210, a control module 220, an output module 230, a DB management module 240, and frequency DB 250.

The term ‘module’, as used herein, refers to, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

The input module 210 is a unit to which a user inputs input data. The input module 210 is a module which senses selection of a file by a user or selection of a sorting criterion of a file. The input module 210 may include a variety of devices such as a keyboard, a mouse, a touch pad, etc.

The control module 220 recognizes an access to a file sensed by the input module 210 and provides information regarding this recognition to the DB management module 240. If information regarding a sorting criterion is provided to the control module 220 from the input module 210, the control module 220 sorts a file according to the sorting criterion. When the sorting criterion is frequency of use, the control module 220 receives frequencies of use as information regarding frequencies of use of a file and a folder from the DB management module 240, thereby performing a sorting operation based on the frequency of use.

In the sorting operation based on the frequency of use, files in a specific folder or lower folders are displayed in descending or ascending order based on the frequency of use provided by the DB management module 240. In another embodiment, a file or folder having a frequency equal to or less than 1 may be moved to a predetermined folder, for example, a temporary folder, or be compressed and stored. In another embodiment, a file or folder having a frequency equal to or less than 1 and unused for more than 2 years may be deleted. Here, the frequency of use value or period of non-use may differ for different users, and thus may be adaptively determined according to a user's environment.

In the case of a file or folder having the same frequency, if there is a sorting method designated by a next priority, the file or folder may be sorted by that sorting method.

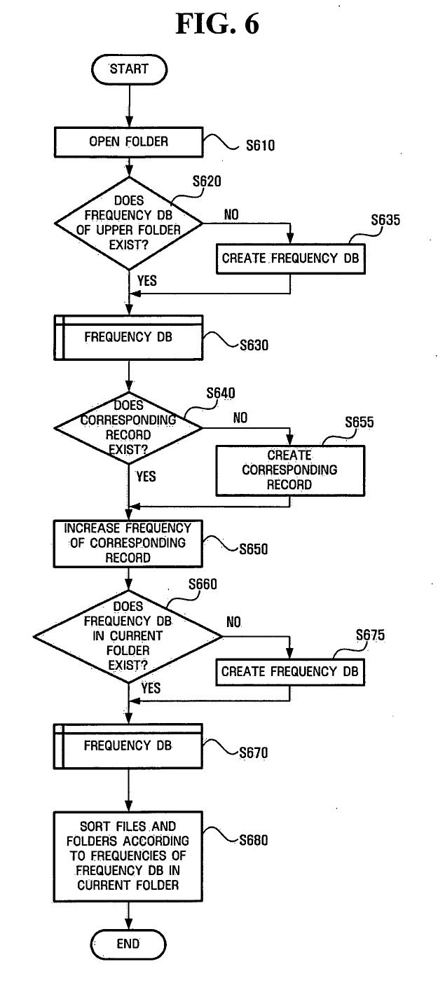

The DB management module 240 generates and manages the frequency DB 250. The DB management module 240 modifies a corresponding record in the frequency DB 250 using information regarding an access to a file provided by the control module 220. When there is a change in a folder or file, the DB management module 240 reflects the change in the corresponding record, and a detailed operation thereof will be described later with reference to FIGS. 6 through 10.

The output module 230 displays files and/or folders in WINDOWS® in a sorted order according to the result of the sorting performed by the control module 220. The output module 230 displays the files and/or folders based on the frequency of use in descending or ascending order. In another embodiment, a file or folder having a predetermined frequency, for example, equal to or less than 1, may not be displayed.

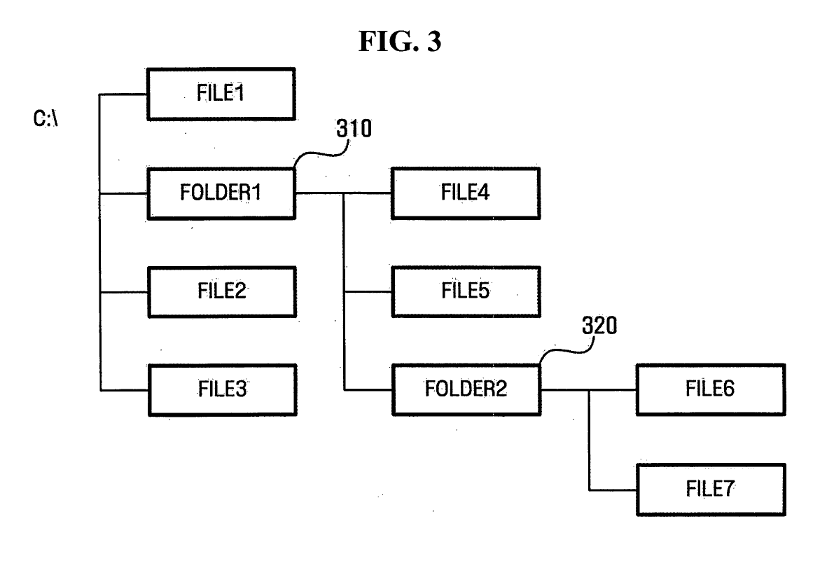

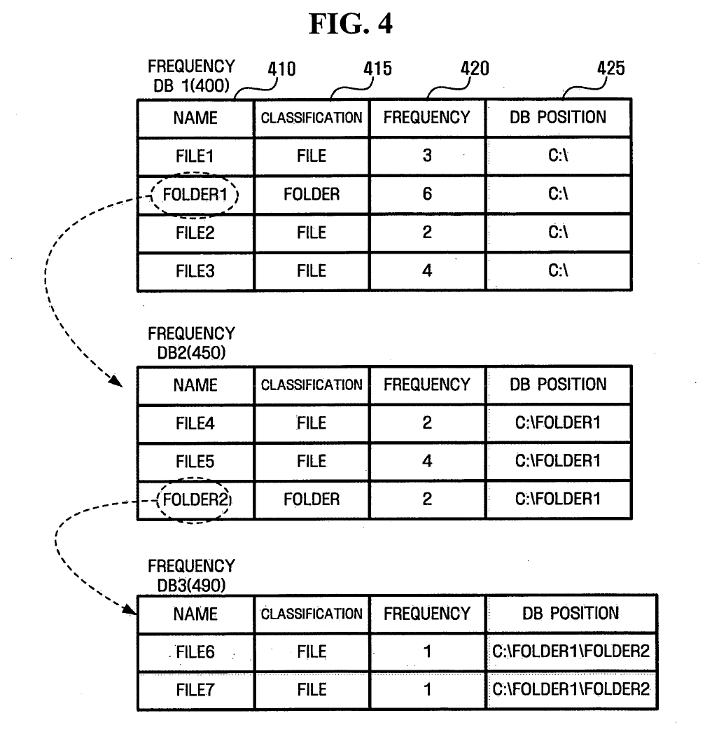

FIG. 3 illustrates a hierarchy structure of example files and folders, and FIG. 4 illustrates a frequency DB corresponding to the files and folders having the hierarchy structure shown in FIG. 3 according to another embodiment of the present invention.

Referring to FIGS. 3 and 4, frequency DB 1 (400) is a frequency DB corresponding to a root directory of a drive C of the hierarchy structure of the files and folders shown in FIG. 3. The frequency DB 1 (400) includes a name of a file (410), classification information (415) used to classify a file or folder, frequencies indicating the number of times of use of a file or folder (420), and position information (425) indicating a path of the current DB. In another embodiment, information regarding a method of sorting files in a current folder may be additionally included. The information may be used as information regarding a sorting criterion having a next priority when the user selects a sorting method different from the current sorting method. In the case of the frequency DB 1(400), a file 1, a folder 1, a file 2, and a file 3 exist in the root directory of the drive C, and the frequency DB 1(400) indicates that only the folder 1 (310) is a folder (415). Since the frequency (420) of the folder 1 (310) is 6, it can be seen that the folder 1 (310) has been opened by the user 6 times, and since DB position information (425) is “C:/”, it can be seen that the current DB 1(400) exists in “C:/”. A frequency DB may be stored in the format of a text file or an INI file having a hidden attribute in a corresponding folder, or in the format of a DB for a PC, or other such formats.

Since the folder 1 (310) shown in FIG. 3 has a file 4, a file 5, and a folder 2 in a lower position, a corresponding frequency DB, that is, frequency DB 2 (450) is included in the folder 1 (310). The frequency DB 2 (450) also has information regarding a file in a corresponding folder. According to the classification information (415), the file 4 and the file 5 are files, and the folder 2 is a folder. The current frequency DB 2 (450) exists in a corresponding position of “C:/folder 1”.

In addition, since the folder 2 (320) has a file 6 and a file 7 in a lower position, a corresponding frequency DB, that is, frequency DB 3 (490), is included in the folder 2.

As shown in FIG. 4, the frequency DB reflects a hierarchy structure of files and/or folders without changes. However, since the frequency DB corresponding to each folder includes only information about files in the corresponding folder, there is no correlation between one frequency DB and another frequency DB. That is, each frequency DB is independent of another frequency DB. Thus, the frequency DB is a relational DB but independent, there is no joint operation between DBs, and even though the capacity of the hard disc is increasing greatly, record modification of the frequency DB and operational speed of frequency sorting is not affected by these increases in capacity.

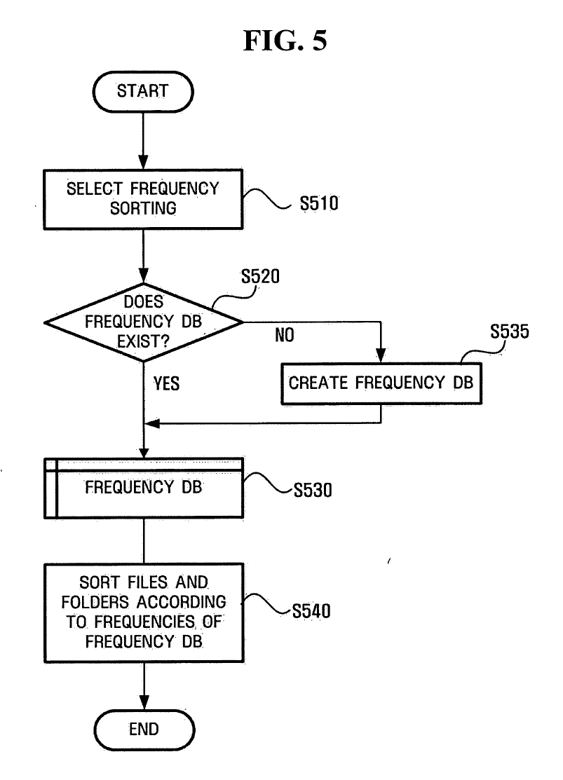

FIG. 5 is a flowchart illustrating a method of sorting files and folders based on frequency of use according to an embodiment of the present invention.

Referring to FIG. 5, in operation S510, a user selects frequency sorting as a method of sorting files in a specific folder. In operation S520, the DB management module 240 determines whether or not a corresponding frequency DB exists in the specific folder. If the corresponding frequency DB exists in the specific folder, the user has access to the frequency DB in operation S530, and the file and the folders are sorted according to the frequencies (420) in the frequency DB in operation S540. If it is determined in operation S520 that the corresponding frequency DB does not exist in the folder to be sorted by the user, a frequency DB is created in operation S535, and then an access to the frequency DB is performed in operation S530.

In this embodiment of the present invention, frequencies of use of a file may affect sorting and displaying files and managing them. As described previously in FIG. 2, the control module 220 may move a file or folder having a predetermined frequency, for example, a frequency equal to or less than 1, to a predetermined folder such as a temporary folder, may compress and store the file or folder, or may delete the file or folder when it has been not used for a predetermined amount of time, for example, for more than 2 years.

Therefore, file management, for example, modification of a file, directly affects frequencies of use of the file, and this is reflected in sorting and displaying files. In this way, the frequencies of a file have a close relation with sorting and displaying files and affect management of files.

A record in the frequency DB may be created, deleted, or modified according to changes of a file, or may be moved or copied to a second frequency DB from a first frequency DB. In addition, file changes that affect a record in the frequency DB may include creating, deleting, executing, moving, and copying a file. Thus, an operation performed on the frequency DB corresponds to a change of a file. Further, an operation performed on the frequency DB relates to various combinations of changes of a file. Examples of possible combinations may be classified as follows.

1. creating a record—creating a file and moving or copying a file in view of a destination folder

2. deleting a record—deleting a file and moving a file in view of a source folder

3. moving a record—moving a file

4. copying a record—copying a file

5. modifying a record—executing a file

Processing a frequency DB according to changes of a file in each case will be described in detail with reference to FIGS. 6 through 10. In the present specification, what is meant by executing a file embraces executing an executable file and reading and writing a file, that is, an operation of opening a file to perform these operations.

FIG. 6 is a flowchart of a processing operation, resulting from a folder being opened, of the method of sorting files and folders based on the frequency of use according to an embodiment of the present invention. Specifically, FIG. 6 illustrates the operation of modifying a frequency of use record in response to the folder being opened according to the frequency of execution of the file.

If a user opens a specific folder in operation S610, since the frequency of use (420) corresponding to the folder should be modified, it is determined whether a frequency DB exists in an upper folder in operation S620. If a frequency DB does not exist in the upper folder, a new frequency DB is created in operation S635. If a frequency DB does exist in the upper folder, the user has access to the frequency DB in operation S630 and determines whether the corresponding record exists in the selected folder in operation S640. If the corresponding record exists in the selected folder, the frequency of use of the corresponding record increases by one in the selected folder in operation S650. On the other hand, if the corresponding record does not exist in the selected folder, a new record is created in operation S655 and then the frequencies are set to 1 in operation S650.

After the frequency information in the selected folder is modified, files and folders in the selected folder are sorted and displayed according to the frequency of use (420) in the frequency DB in operation S680. Thus, it is determined whether the corresponding frequency DB exists in the selected folder in operation S660. If the frequency DB exists in the selected folder, the user has access to the frequency DB in operation S670, and files and folders in the opened folder are sorted according to the frequency of use (420) in operation S680. If the frequency DB does not exist in the selected folder, a corresponding frequency DB is created in the opened folder in operation S675.

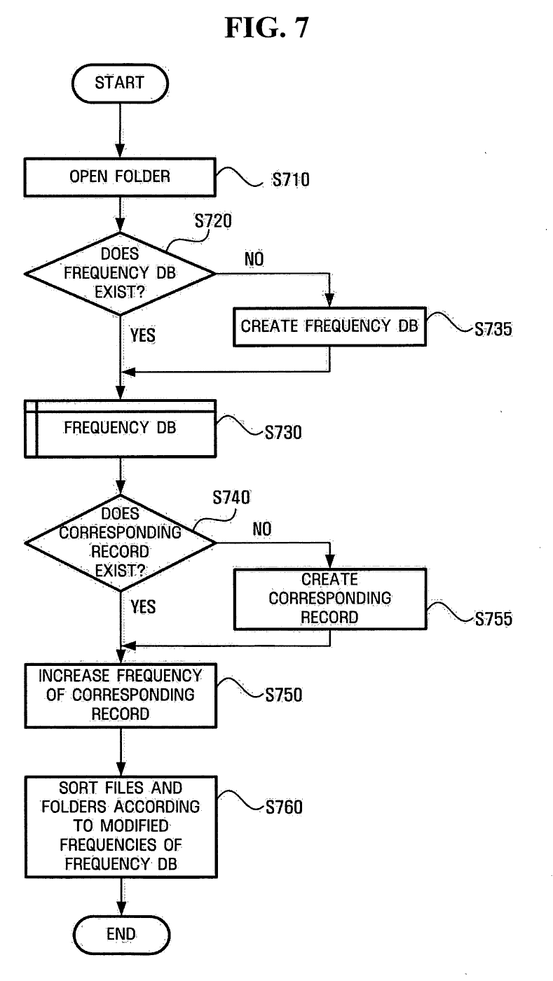

FIG. 7 is a flowchart of a processing operation, resulting from a file being opened, of the method of sorting files and folders based on the frequency of use according to an embodiment of the present invention. Specifically, FIG. 7 illustrates the operation of modifying a frequency of use record in response to the file being opened based on the execution of the file.

If a user opens a specific file in operation S710, it is determined whether a frequency DB exists in a folder in which the file exists in operation S720. If the frequency DB exists in the folder, the user has access to the frequency DB in operation S730 and determines whether the corresponding record exists in the opened file in operation S740. If the frequency DB does not exist in the folder, a new frequency DB is created in operation S735.

When the record corresponding to the opened file exists in the frequency DB, the frequency of use of the corresponding record increases by one in operation S750, and then, files and folders in the folder are resorted according to the modified frequency of use in operation S760. When the record corresponding to the opened file does not exist in the frequency DB, a new record is created in operation S755, and frequencies are set to 1 in operation S750.

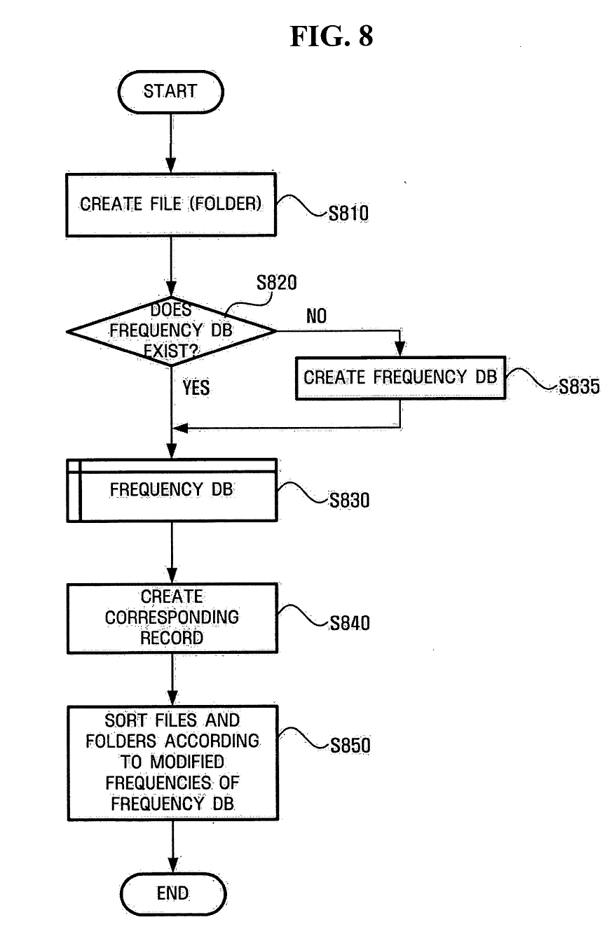

FIG. 8 is a flowchart of a processing operation resulting from a file being created, according to an embodiment of the present invention. Specifically, FIG. 8 illustrates the operation of creating a frequency record by creating the file. Creating the file includes creating a new file that has not existed, and moving or copying a file from one folder to another folder to create a new file without succeeding to a previous frequency record from a destination folder.

If the user creates a file in operation S810, it is determined whether a frequency DB exists in a folder to which the file belongs in operation S820. If the frequency DB exists in the folder, the user has access to the frequency DB in operation S830, creates a new corresponding record, and sets the frequency to 1 in operation S840. If a frequency DB does not exist in the folder, the user creates a frequency DB in operation S835, has access to the frequency DB in operation S830, and creates a corresponding record in operation S840. If the operation of modifying the record is completed, files and folders are resorted based on the frequency of use of the modified frequency DB in operation S850.

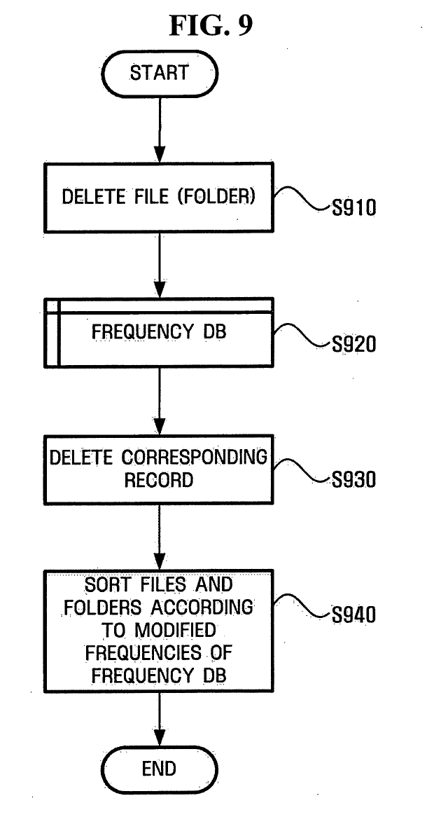

FIG. 9 is a flowchart of a processing operation resulting from a file being deleted, according to an embodiment of the present invention. Specifically, FIG. 9 illustrates the operation of deleting a frequency record by deleting a file. Deleting a file includes permanently deleting a file from a storage device, and deleting an original file from a source folder in response to a file being moved or copied from one folder to another folder.

If the user deletes a file in operation S910, the user has access to a frequency DB in a folder to which the file belongs in operation S920 and deletes a corresponding record in operation S930. If the operation of modifying the record is completed, files and folders are resorted based on frequency of use of the modified frequency DB in operation S940.

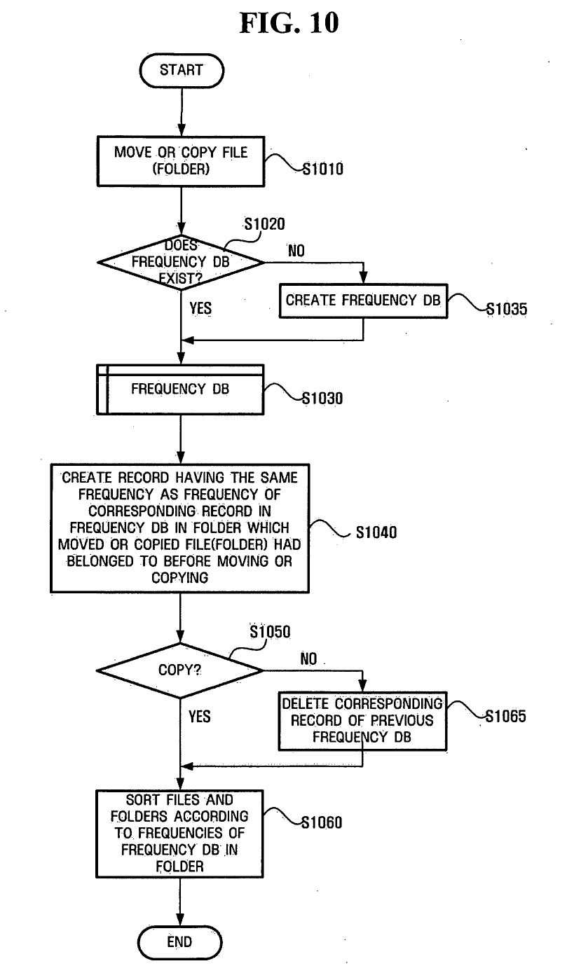

FIG. 10 is a flowchart of a processing operation resulting from a file being moved or copied, according to an embodiment of the present invention.

When a file moves, a file in a source folder is deleted and the same file is created in a destination folder. Deleting a file in the source folder may be performed through the above-described operation shown in FIG. 9. Creating a file in the destination folder may be performed by creating a new frequency record with a succession of frequencies of a corresponding frequency record in the source folder, or by creating a new frequency record having a frequency of use reset to 1. Creating the new frequency record having a frequency of use reset to 1 may be performed through the above-described operation shown in FIG. 8.

When a file is copied, unlike when a file moves, an original file exists in the source folder and the same file is created in the destination folder. Thus, creating a file in the destination folder may be performed in the same manner as when a file moves.

FIG. 10 specifically illustrates a processing operation resulting from a file being moved or copied with a succession of frequencies of a corresponding frequency record in the source folder. If the user moves or copies a file in operation S1010, it is determined whether a frequency DB exists in a destination folder in operation S1020. If a frequency DB exists in the destination folder, the user has access to the frequency DB in operation S1030, and a record having the same frequency of use as a corresponding record of the frequency DB in the source folder is created in operation S1040. If a frequency DB does not exist in the destination folder, a frequency DB is created in operation S1035, the user has access to the frequency DB in operation S1030, and a record having the same frequency of use as the corresponding record of the frequency DB in the source folder is created in operation S1040. When a file moves, an operation of deleting the corresponding frequency record from the source folder (S1065) is additionally performed. Files and folders are resorted based on the frequency of use of the modified current frequency DB in operation S1060.

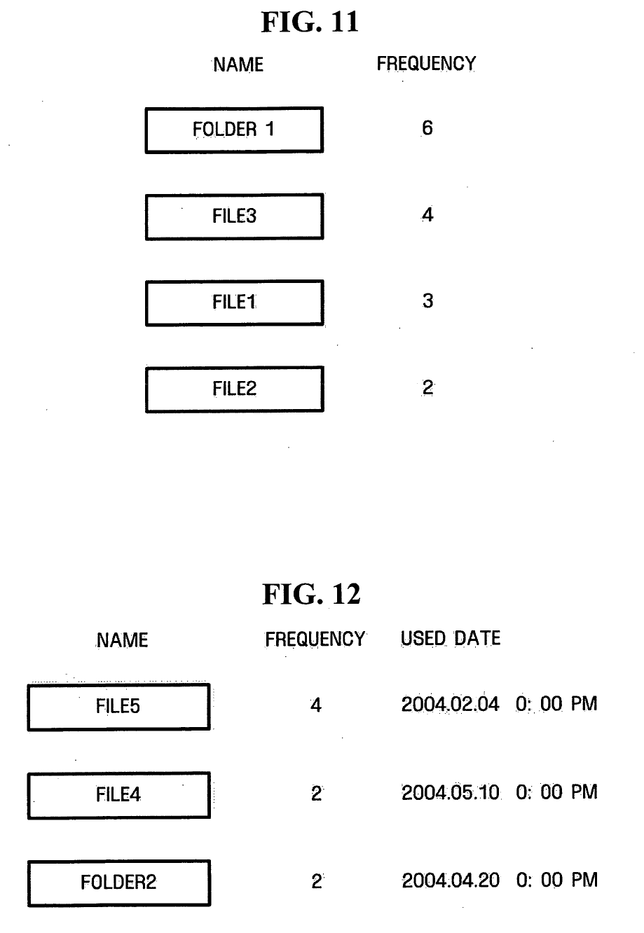

FIG. 11 illustrates frequency sorting according to an embodiment of the present invention.

Specifically, FIG. 11 illustrates the result of sorting files and folders in a directory “C:/” according to the frequencies (420) of the frequency DB 1 (400) of FIG. 4. FIG. 11 illustrates the result of sorting files and folders based on the frequencies in descending order. In another embodiment, files and folders may be sorted based on the frequencies in ascending order. In yet another embodiment, a file having low frequencies may not be displayed, or only summary information about the file may be displayed.

FIG. 12 illustrates a sorting method resulting form a plurality of files, etc., having the same frequencies existing, according to an embodiment of the present invention.

When the files and folders in a folder 1 are sorted based on frequency of use of the frequency DB 2 (450) of FIG. 4, a file 4 and a folder 2 have the same frequencies. Thus, a secondary sorting order may be considered. In an embodiment, files etc. having the same frequencies may be sorted by a sorting method designated by a next priority.

FIG. 12 illustrates an example in which the file 4 and the folder 2, having the same frequencies, are sorted in descending order based on a date of use.

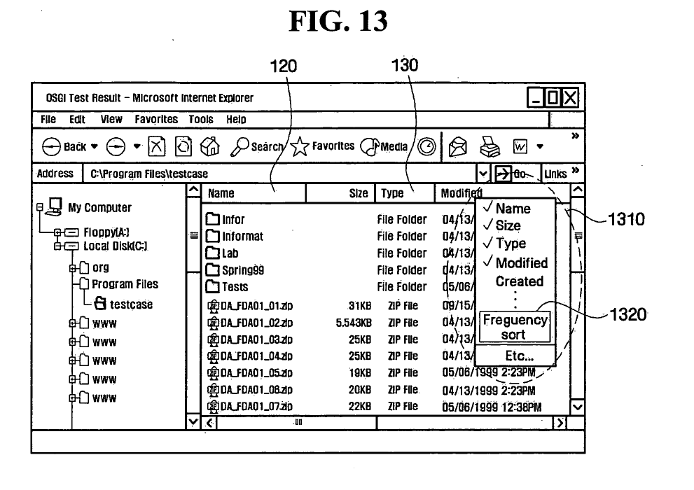

FIG. 13 illustrates a user interface used to select frequency sorting according to an embodiment of the present invention.

When the user selects frequency sorting (1320) by adding the frequency sorting (1320) to information (1310) regarding a file provided by a WINDOWS® seeker, the frequencies of files, etc., are displayed on a window, and by clicking a frequency tab, files, etc., are sorted and displayed, for example, in descending order based on frequency of use.

As described above, in the method of, and apparatus to perform, sorting and displaying files and/or folders based on frequency of use according to the present invention, a file and/or folder can be sorted based on the frequency of use such that the file or folder used many times is displayed in an upper position, and a time required for seeking a file can be reduced. In addition, the present invention provides a frequency DB having a hierarchy structure for independently managing information about frequencies of use for each file and/or folder. Therefore, quick sorting can be achieved without being affected by an increase in the capacity of a hard disc.

Although a few embodiments of the present invention have been shown and described, it would be appreciated by those skilled in the art that changes may be made in these embodiments without departing from the principles and spirit of the invention, the scope of which is defined in the claims and their equivalents.

1. An apparatus to sort files and/or folders based on frequencies of use, the apparatus comprising:
an input module to receive a frequency sorting selection regarding a specific folder;
a frequency database including information regarding the frequencies of the files and/or lower folders in the folder in which frequency sorting is performed in response to the frequency sorting selection;
a database management module to create and manage the frequency database;
a control module to sort the files and/or lower folders according to the frequencies provided by the database management module; and
an output module to display the result of the frequency sorting performed by the control module.

2. The apparatus of claim 1, wherein the frequency database is arranged according to a hierarchical structure of the files and/or folders.

3. The apparatus of claim 1, wherein the frequency database includes identification information and the frequency of at least one of the files and the lower folders in the folder.

4. The apparatus of claim 1, wherein the database management module reflects a change in a corresponding record in the frequency database in response to a change occurring in one of the files or lower folders in the folder in which the frequency sorting is performed.

5. The apparatus of claim 4, wherein the reflecting the change results in an access of the frequency database in the folder in which the frequency sorting is performed, and an increase of the frequencies of use of the corresponding record, in response to the one of the lower folders being opened.

6. The apparatus of claim 4, wherein the reflecting the change results in an access of the frequency database in the folder in which the frequency sorting is performed, and an increase of the frequencies of use of the corresponding record, in response to the one of the files being opened.

7. The apparatus of claim 4, wherein the reflecting the change results in an access of the frequency database in the folder in which the frequency sorting is performed, and creation of the corresponding record, in response to a new file or lower folder being created in the folder in which the frequency sorting is performed.

8. The apparatus of claim 4, wherein the reflecting the change results in an access of the frequency database in the folder in which the frequency sorting is performed, and deletion of the corresponding record, in response to the one of the files or lower folders being deleted from the folder in which the frequency sorting is performed.

9. The apparatus of claim 4, wherein the reflecting the change results in an access of the frequency database in the folder in which the frequency sorting is performed, and creation of an identical record as a corresponding record of a frequency database in another folder, in response to a file or lower folder in the other folder being moved or copied to the folder in which the frequency sorting is performed.

10. The apparatus of claim 1, wherein the control module further sorts the files and/or folders using a sorting method designated by a secondary priority in response to at least two of the sorted files and/or folders having identical frequencies.

11. The apparatus of claim 1, wherein the control module moves one of the files or lower folders to a predetermined folder in response to the frequency of the one of the files or lower folders being smaller than a predetermined value.

12. The apparatus of claim 1, wherein the control module compresses and stores one of the files or lower folders in response to the frequency of the one of the files or lower folders being smaller than a predetermined value.

13. The apparatus of claim 1, wherein the control module deletes one of the files or lower folders in response to the frequency of the one of the files or lower folders being smaller than a predetermined value and not being used for a predetermined amount of time.

14. A method of sorting files and/or folders based on frequencies of use, the method comprising:
inputting a frequency sorting selection so that the files and/or lower folders in a specific folder are sorted based on the frequencies of use;
accessing a frequency database including information regarding the frequencies of the files and/or lower folders in the folder in which the frequency sorting is performed in response to the frequency sorting selection;
sorting the files and/or lower folders in the folder based on the frequencies in the frequency database; and
displaying the result of the sorting.

15. The method of claim 14, wherein the frequency database is arranged according to a hierarchical structure of the files and/or folders.

16. The method of claim 14, wherein the frequency database includes identification information and the frequency of at least one of the files and the lower folders in the folder.

17. The method of claim 14, further comprising reflecting a change in a corresponding record in the frequency database in response to a change occurring in one of the files or lower folders in the folder in which the frequency sorting is performed.

18. The method of claim 14, wherein the sorting the files and/or lower folders further comprises using a sorting method designated by a secondary priority in response to at least two of the sorted files and/or folders having the same frequencies.

19. The method of claim 14, wherein the sorting the files and/or lower folders further comprises moving one of the files or lower folders to a predetermined folder in response to the frequency of the one of the files or lower folders in the folder being smaller than a predetermined value.

20. The method of claim 14, wherein the sorting the files and/or lower folders further comprises compressing and storing one of the files or lower folders in response to the frequency of the one of the files or lower folders being smaller than a predetermined value.

21. The method of claim 14, wherein the sorting the files and/or lower folders further comprises deleting one of the files or the lower folders in response to the frequency of the one of the files or the lower folders being smaller than a predetermined value and not being used for a predetermined amount of time.

22. A recording medium having a computer readable program recorded therein, the program causing the computer to execute a method of sorting files and/or folders based on frequencies of use, the method comprising:
inputting a frequency sorting selection so that the file and/or lower folders in a specific folder are sorted based on the frequencies of use;
accessing a frequency database including information regarding the frequencies of the files and/or lower folders in the folder in which the frequency sorting is performed in response to the frequency sorting selection;
sorting the files and/or lower folders in the folder based on the frequencies in the frequency database; and
displaying the result of sorting.

23. An apparatus to sort files and/or folders based on frequencies of use, the apparatus comprising:
a frequency database including information regarding the frequencies of the files and/or lower folders in a folder in which frequency sorting is performed; and
a control module to sort the files and/or lower folders according to the frequencies provided by the frequency database.

24. The apparatus of claim 23, wherein a frequency of one of the files and/or lower folders is increased in response to the one of the files and/or lower folders being accessed.

25. The apparatus of claim 23, wherein the files and/or lower folders are displayed in descending or ascending order based on the frequencies provided by the frequency database.

26. A method of sorting files and/or folders based on frequencies of use, the method comprising:
sorting the files and/or lower folders in a folder based on the frequencies of use; and
displaying the results of the sorting.

27. The method of claim 26, wherein the displaying the results of the storing comprises displaying the files and/or lower folders in ascending or descending order based on the frequencies of use.

28. The method of claim 26, further comprising accessing a frequency database having information regarding the frequencies of the files and/or the lower folders.

29. The method of claim 28, wherein the frequency data base comprises separate records for all folders having the files and/or lower folders, and the records are updated in response to any one of the files and/or lower folders being accessed.

30. The method of claim 26, further comprising displaying options which a user selects to sort the files and/or lower folders, wherein at least one of the options is the frequencies of use of the files and/or lower folders.
